(19) United States
(12) Patent Application Publication
(10) Pub. No.: US 2024/0281615 A1
(43) Pub. Date: Aug. 22, 2024

(54) STORAGE MEDIUM STORING PROGRAM FOR DISPLAYING VOICE MESSAGE, CONTROL METHOD, AND INFORMATION PROCESSING APPARATUS

(71) Applicant: CANON KABUSHIKI KAISHA, Tokyo (JP)

(72) Inventor: RYO DEGAWA, Ibaraki (JP)

(21) Appl. No.: 18/582,064

(22) Filed: Feb. 20, 2024

(30) Foreign Application Priority Data
Feb. 21, 2023 (JP) 2023-025294

(51) Int. Cl. G06F 40/35; G06F 16/34; G06T 11/00; H04L 12/18

(52) U.S. Cl. CPC G06F 40/35; G06F 16/345; G06T 11/001; H04L 12/1813

(57) ABSTRACT

A storage medium storing a program for causing a computer to execute a control program for controlling an information processing apparatus, which makes it possible to confirm the content of a voice message in a chat room even in a case where the voice message cannot be reproduced. The information processing apparatus executes processing for summarizing content of a voice message in a chat room where chats are posted by a plurality of users. The information processing apparatus displays the summarized content in a state associated with the voice message.

### BACKGROUND OF THE INVENTION

### Field of the Invention

The present invention relates to a storage medium storing a program for displaying a voice message, a control method, and an information processing apparatus.

### Description of the Related Art

In recent years, communication between users using a chat system has become popular. This chat system provides a service that makes it possible to perform communication, by transmitting not only characters but also a voice message from a sending person side, and reproducing the voice message on a receiving person side. Further, a technique disclosed in Japanese Laid-Open Patent Publication (Kokai) No. 2021-110911 is an apparatus in which, as handling of voice data, a recognition processor converts input voice data to text data and displays the text data as characters which can be recognized by a display section (see, for example, Japanese Laid-Open Patent Publication (Kokai) No. 2021-110911).

However, there is a problem that the voice message displayed on a chat window of the chat system is only displayed as an icon for reproducing the voice message, and the content of the message cannot be confirmed until the voice is reproduced. For example, in a place where outputting of sound is inhibited, it is impossible to immediately confirm the message. On the other hand, if the voice data is all converted to characters for display as performed in the apparatus disclosed in Japanese Laid-Open Patent Publication (Kokai) No. 2021-110911, there is a problem that the visibility is degraded.

### SUMMARY OF THE INVENTION

The present invention provides a storage medium storing a program for causing a computer to execute a control program for controlling an information processing apparatus, which makes it possible to confirm the content of a voice message in a chat room even in a case where the voice message cannot be reproduced, the control method, and the information processing apparatus.

In a first aspect of the present invention, there is provided a non-transitory computer-readable storage medium storing a program for causing a computer to execute a control method of controlling an information processing apparatus, the control method including causing the information processing apparatus to execute processing for summarizing content of a voice message in a chat room where chats are posted by a plurality of users, and causing the information processing apparatus to display summarized content in a state associated with the voice message.

In a second aspect of the present invention, there is provided a method of controlling an information processing apparatus, including causing the information processing apparatus to execute processing for summarizing content of a voice message in a chat room where chats are posted by a plurality of users, and causing the information processing apparatus to display summarized content in a state associated with the voice message.

Further features of the present invention will become apparent from the following description of exemplary embodiments (with reference to the attached drawings).

### BRIEF DESCRIPTION OF THE DRAWINGS

FIG. 1 is a diagram showing the configuration of a system according to a first embodiment of the present invention.

FIG. 2 is a block diagram showing the configuration of a chat application server in the present embodiment.

FIG. 3 is a block diagram showing the configuration of each of mobile terminals in the present embodiment.

FIGS. 4A to 4C are diagrams each useful in explaining an operation screen of a chat application in the present embodiment.

FIG. 5 is a flowchart of a message transmission/reception process performed by the chat application server in the present embodiment.

FIG. 6 is a flowchart of a message reception process performed by the mobile terminal in the present embodiment.

FIG. 7 is a flowchart of a read message transmission process for transmitting a read message to the chat application server when a message is displayed in a chat room of the mobile terminal.

FIG. 8 is a flowchart of a read-state information reception process performed by the mobile terminal in the present embodiment.

FIG. 9 is an explanatory diagram showing a chat management table in the present embodiment.

FIG. 10 is an explanatory diagram showing a sequence of operations performed by the whole chat system in the present embodiment.

FIG. 11 is a flowchart of a caption generating-and-displaying process performed by the mobile terminal in the present embodiment.

FIG. 12 is an explanatory diagram showing the display of the chat room in the present embodiment.

FIG. 13 is an explanatory diagram showing a voice message management table in the present embodiment.

FIG. 14 is a flowchart of a message transmission process performed by a mobile terminal in a second embodiment of the present invention.

FIG. 15 is an explanatory diagram showing a display screen of a chat room in the present embodiment.

FIG. 16 is an explanatory diagram showing a voice message management table in the present embodiment.

FIG. 17 is a flowchart of a voice message displaying process operation performed according to caption settings of the mobile terminal in the present embodiment.

FIG. 18 is a flowchart of a voice message search process performed by the mobile terminal in a third embodiment of the present invention.

FIGS. 19A to 19D are diagrams each useful in explaining a display screen of the chat room in the present embodiment.

### DESCRIPTION OF THE EMBODIMENTS

The present invention will now be described in detail below with reference to the accompanying drawings showing embodiments thereof. The following description of the configuration of the embodiments is given by way of example, and the scope of the present invention is not limited to the described configurations of the embodiments. First, a first embodiment of the present invention will be described.

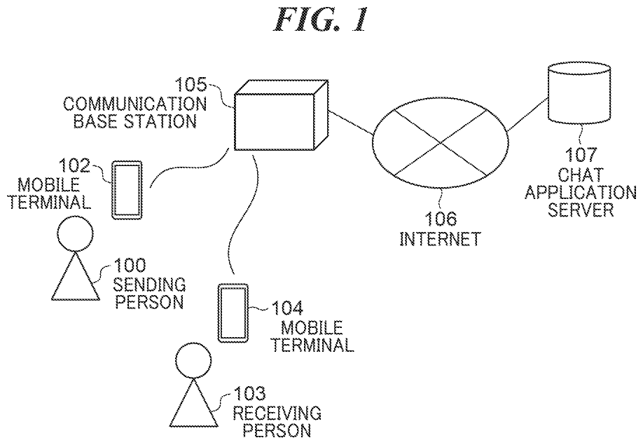

FIG. 1 is a diagram showing an example of the configuration of a system according to the first embodiment of the present invention. This system includes a communication base station 105 and a chat application server 107, and these are communicably connected to each other via the Internet 106. The communication base station 105 communicates necessary information with a mobile terminal 102 owned by a sending person 100 and a mobile terminal 104 owned by a receiving person 103.

The sending person 100 sends a voice message by a chat application installed in the mobile terminal 102. Next, the voice message sent by the sending person 100 is transmitted to the chat application server 107 via the communication base station 105 and the Internet 106. Next, the chat application server 107 performs predetermined processing on the received voice message and transmits the processed voice message to a destination. Then, the voice message transmitted by the chat application server 107 is transmitted to the mobile terminal 104 owned by the receiving person 103 via the Internet 106 and the communication base station 105.

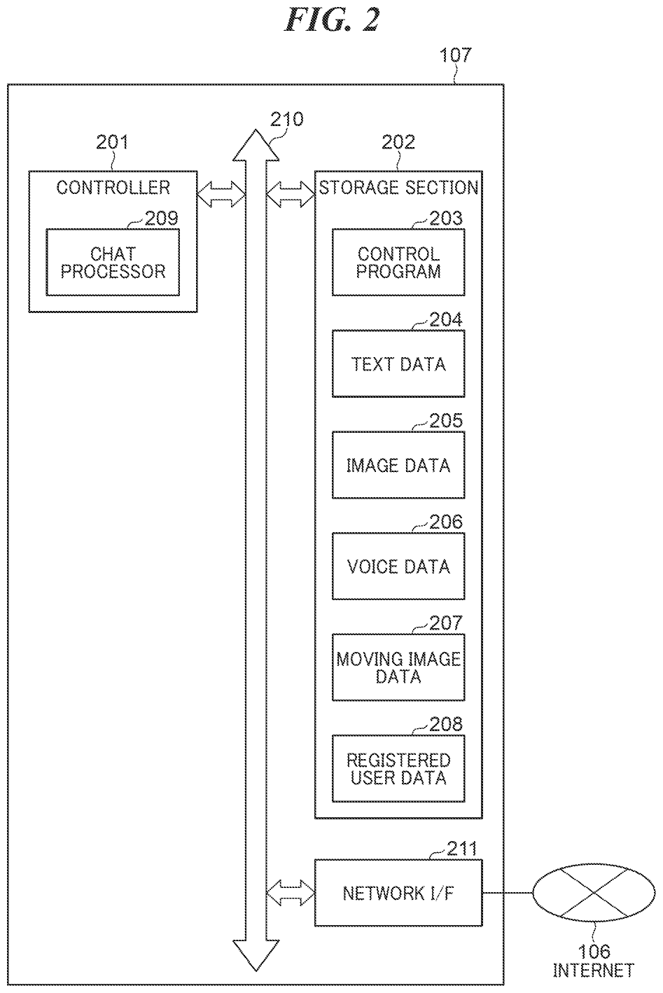

FIG. 2 is a block diagram showing the configuration of the chat application server 107 according to the present embodiment. The chat application server 107 includes a controller 201, a storage section 202, and a network interface 211, and these components are connected by a system bus 210 in a state enabled to transmit and receive necessary information to and from each other.

The controller 201 loads and executes a control program 203 non-volatily stored in the storage section 202. With this, a variety of functions necessary for the chat application server 107 are realized. The controller 201 is comprised of at least one processor, such as a central processing unit (CPU) or a digital signal processor (DSP). Further, the controller 201 includes a chat processor 209 and performs centralized control of the devices connected to the system bus 210. The chat processor 209 interprets a message received from the chat application of the mobile terminal 102 and sends a response. Thus, the chat application server 107 has an automatic interaction function and also functions as a chatbot.

The storage section 202 is used as an internal storage. The storage section 202 stores the control program 203, text data 204, image data 205, voice data 206, moving image data 207, registered user data 208, system software, and so forth. The storage section 202 is implemented by a storage device, such as a hard disk drive (HDD), a solid-state drive (SSD), or a random-access memory (RAM).

The text data 204 is text data of messages posted by users or chatbots in chats. The image data 205 is image data posted by users in chats. The voice data 206 is voice data of voice messages posted by users in chats. The moving image data 207 is moving image data of moving image messages posted by users in chats. The registered user data 208 is list information of combinations of user IDs and passwords, each required when each user logs into the chat application.

The network interface 211 is an interface that is connected to the Internet 106 via, for example, a local area network (LAN) cable to perform network communication. For example, a well-known network card or the like can be used.

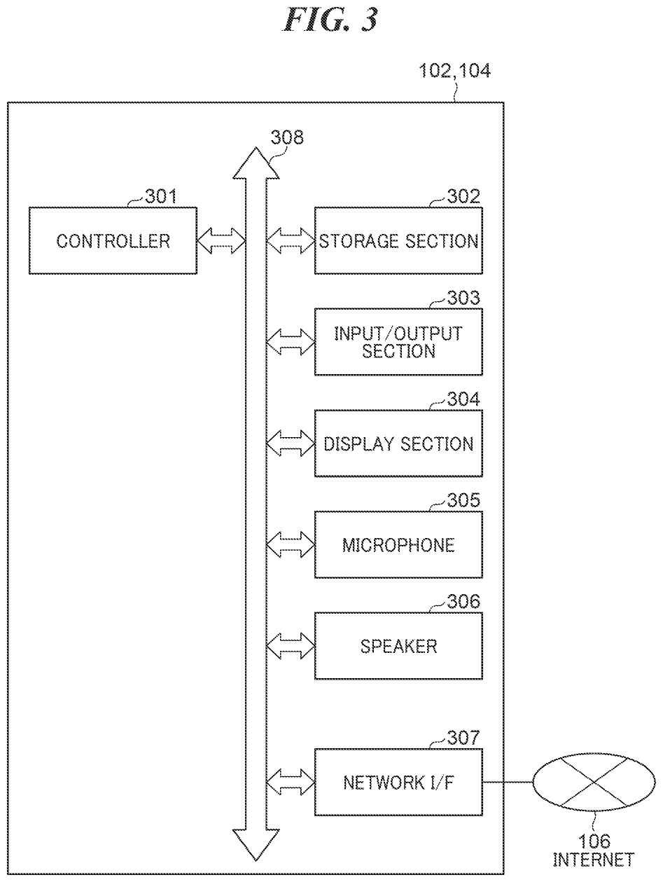

FIG. 3 is a block diagram showing the configuration of each of the mobile terminals 102 and 104. Note that the mobile terminals 102 and 104 are each an example of an information processing terminal which has a communication function and is capable of being used in a free place by being equipped with a wireless communication function or the like. For example, a smartphone, a tablet terminal, a laptop PC, or the like is used.

Both of the mobile terminals 102 and 104 have the same configuration, and hence the configuration of the mobile terminal 102 will be described as a representative. The mobile terminal 102 has a system bus 308. To the system bus 308, a controller 301, a storage section 302, an input/output section 303, a display section 304, a microphone 305, a speaker 306, and a network interface 307 are connected. The devices connected to the system bus 308 are enabled to transmit and receive necessary information to and from each other.

The controller 301 loads and executes control programs non-volatily stored in the storage section 302. With this, a variety of functions necessary for the mobile terminal 102 are realized. The controller 301 is comprised of at least one processor, such as a CPU or a DSP. Further, the controller 301 performs centralized control of the devices connected to the system bus 308.

The storage section 302 is used as an internal storage. The storage section 302 stores control programs, text data, voice data, image data, system software, and so forth. The storage section 302 is implemented by a storage device, such as an HDD, an SSD, or a RAM.

The input/output section 303 is implemented, for example, by a liquid crystal display (LCD) touch panel, for acquiring information input by a user operation and sending the acquired information to the controller 301. Further, the input/output section 303 outputs a result of processing performed by the controller 301. Note that an operation of input from a user can be realized by a hardware input device, such as a switch and a keyboard. As a method for detecting an input to the touch panel, for example, a general detection method, such as a resistance film method, an infrared method, an electromagnetic induction method, or an electrostatic capacitance method, can be employed.

The display section 304 performs the display according to image data. Further, the display section 304 can display an operation screen and provides a user interface (UI) to a user. The microphone 305 is used to input voice data. The speaker 306 is used to output voice data. In the present embodiment, a speaker incorporated in the mobile terminal 102 is used to output voice. Further, the controller 301 can send voice data to a voice output device, such as an external earphone or speaker, which is connected to the mobile terminal 102 from the outside, and cause the voice output device to output voice. The network interface 307 is connected to the Internet 106 to perform network communication.

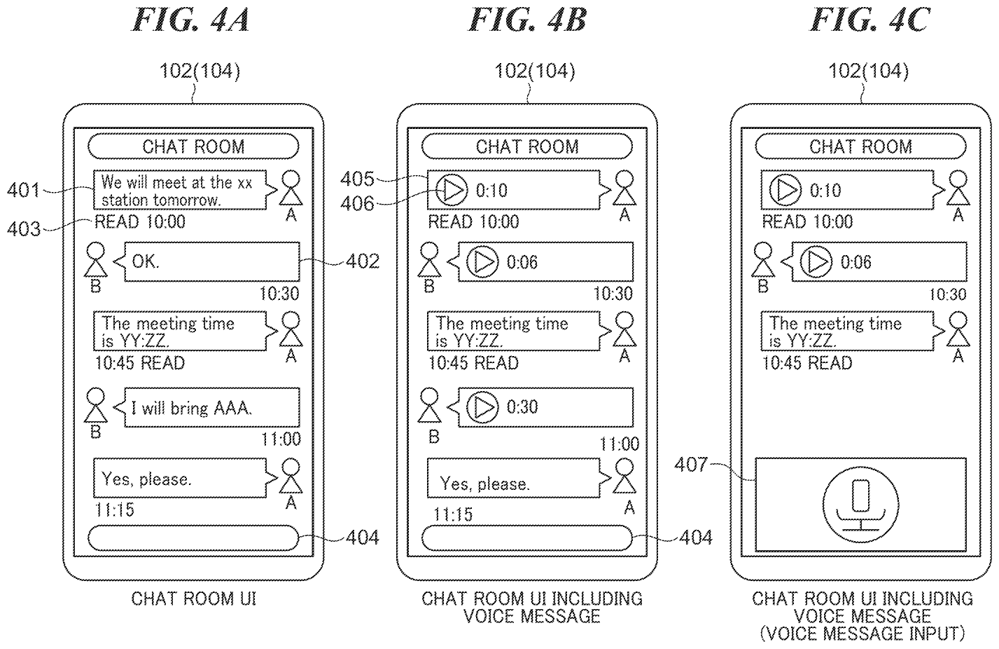

FIG. 4A is an explanatory diagram showing an operation screen of the chat application operating on each of the mobile terminals 102 and 104. At the time of appearance of this operation screen, the chat application is performing necessary communication with the chat application server 107. On the operation screen shown in FIG. 4A, a message 401 of a user A (operator of the present mobile terminal) and a message 402 (chat partner) of a user B are displayed in time series in a vertical downward direction of the screen. Although in the present embodiment, the message 402 of the chat partner (user B) is displayed on the right side of a user icon, it can be configured to be displayed on the left side of the user icon.

On the display screen shown in FIG. 4A, a character string “read” (403) which indicate that the message sent by the user A is displayed by the user B as the chat partner is also displayed on the display screen. Further, as shown in FIG. 4A, a message input field 404 is displayed in a lower portion of the display screen. In the message input field 404, the user inputs text and/or selects image data stored in the storage section 302 and transmits the text and/or image data to the chat application server. With this, the message is transmitted to the user B.

FIG. 4B is an explanatory diagram showing an operation screen of the chat application, including a voice message.

A voice message 405 is displayed differently from a text message, and a button (button icon) 406 for reproducing voice is displayed. Assuming that the user A of the mobile terminal 102 is displaying the operation screen of FIG. 4B, when a voice reproduction instruction is received from the user A who has pressed the button 406, the controller 301 of the mobile terminal 102 performs voice reproduction control. With this, the reproduced voice is output from the speaker 306.

FIG. 4C is an explanatory diagram showing an operation screen for inputting a voice message. When a user presses a voice message input field 407, the chat application starts recording of voice. Assuming that the user A of the mobile terminal 102 is displaying the operation screen of FIG. 4C, the user A inputs voice to the microphone 305 of the mobile terminal 102. To terminate inputting of voice, the user presses the voice message input field 407 again. The chat application stops recording of voice and stores voice message data in the storage section 302. After that, by transmitting the voice message to the chat application server according to a user's instruction, the voice message is transmitted to the receiving person.

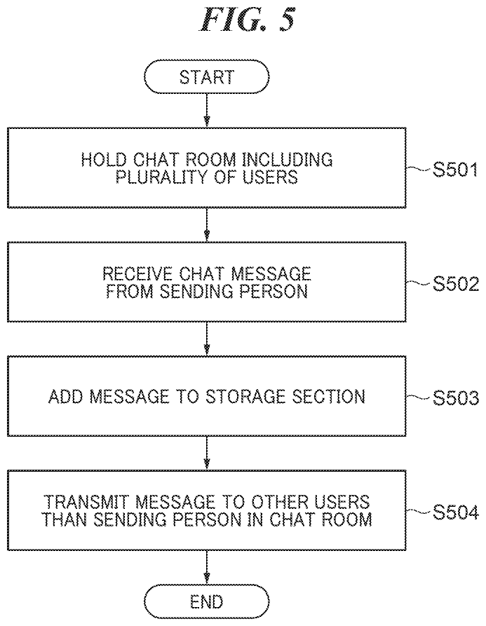

Next, the operation of a message transmission/reception process performed by the chat application server 107 will be described with reference to FIG. 5. The message transmission/reception process in FIG. 5 is realized by the controller 201 (CPU) of the chat application server 107 loading the control program 203 stored in the storage section 202 into the RAM or the like and executing the loaded control program 203. First, in a step S501, the controller 201 holds a chat room including a plurality of users. Next, in a step S502, the controller 201 receives a message from the chat application of the mobile terminal 102 (message-sending person-side terminal).

Next, in a step S503, the controller 201 stores and saves the received message in the storage section 202. Then, in a step S504, the controller 201 transmits the received message to other users in the chat room. Thus, the operation of the chat application server 107 is performed.

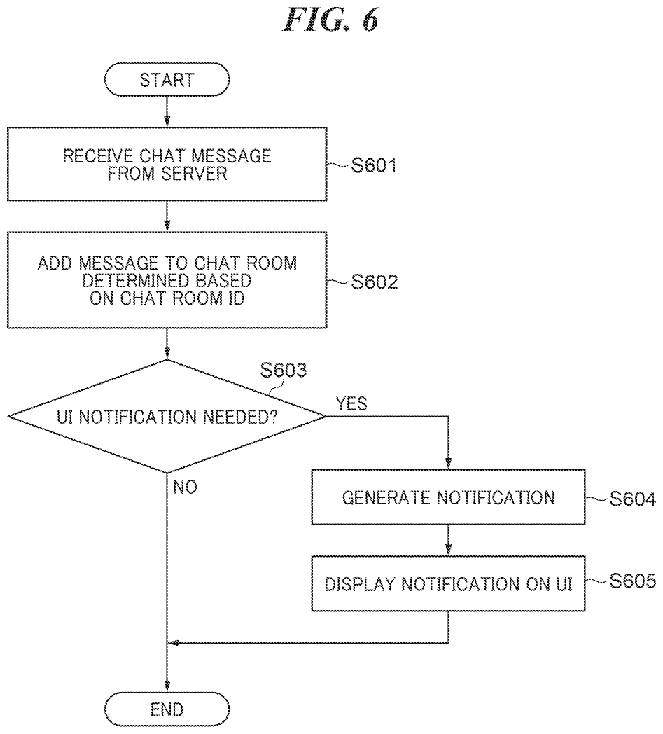

Next, a message reception process performed by the mobile terminal 104 will be described with reference to FIG. 6. The process in FIG. 6 is realized by the controller 301 (CPU) of the mobile terminal 104 loading an associated control program stored in the storage section 302 into the RAM or the like and executing the loaded control program. First, in a step S601, the controller 301 receives a message from the chat application server 107. Next, in a step S602, based on a chat room ID for identifying a chat room, which is included in the message, the controller 301 notifies the message to the corresponding chat room.

Next, in a step S603, the controller 301 determines whether or not it is necessary to notify reception of the message to the user via the user interface (UI). Note that necessity/unnecessity of the notification is set by the user in advance, and a setting thereof is stored in the storage section 302.

Then, if it is determined in the step S603 that the notification is necessary (Yes), the controller 301 proceeds to a step S604. On the other hand, if it is determined that the notification is unnecessary (No), the controller 301 terminates the present process. In the step S604, the controller 301 generates the notification. Then, in a step S605, the controller 301 displays the notification on the display section 304 and causes the user to be informed of the notification by using the speaker 306 according to the setting. Thus operates the mobile terminal 104 having received the message.

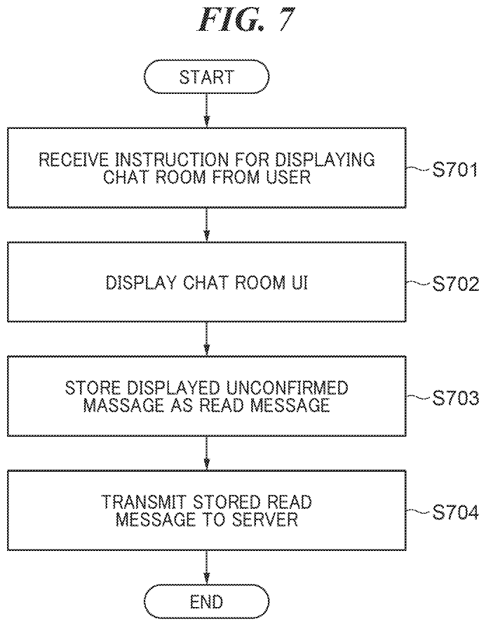

Next, a read message transmission process for transmitting a read message to the chat application server 107 when a message is displayed in a chat room of the mobile terminal 104 will be described with reference to FIG. 7. The read message transmission process in FIG. 7 is realized by the controller 301 of the mobile terminal 104 loading an associated control program stored in the storage section 302 into the RAM or the like and executing the loaded control program. First, in a step S701, the controller 301 receives an instruction for displaying a chat room from the user. Next, in a step S702, the controller 301 displays the selected chat room on the display section 304. Specifically, the chat room is displayed as the user interface.

Next, in a step S703, the controller 301 stores a latest displayed unconfirmed message in the storage section 302 as the read message. Then, in a step S704, the controller 301 transmits the read message stored in the storage section 302 to the chat application server 107. Thus, the read message transmission process is performed by the mobile terminal.

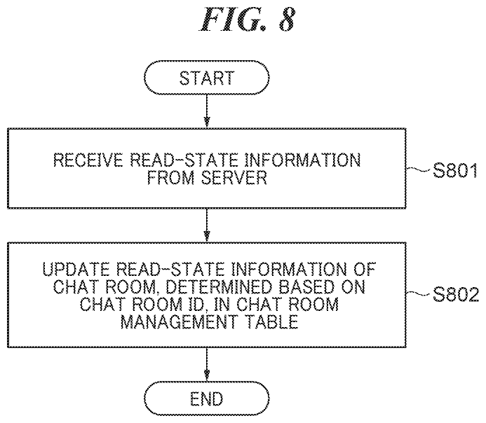

Next, a read-state information reception process performed by the mobile terminal 102 will be described with reference to FIG. 8. The read-state information reception process in FIG. 8 is realized by the controller 301 of the mobile terminal 102 loading an associated control program stored in the storage section 302 into the RAM or the like and executing the loaded control program.

First, in a step S801, the controller 301 receives read-state information from the chat application server 107. Next, in a step S802, based on a chat room ID for identifying a chat room, which is included in the read-state information, the controller 301 updates the read-state information of the corresponding chat room in a chat management table 901. Thus, the read-state information reception operation is performed.

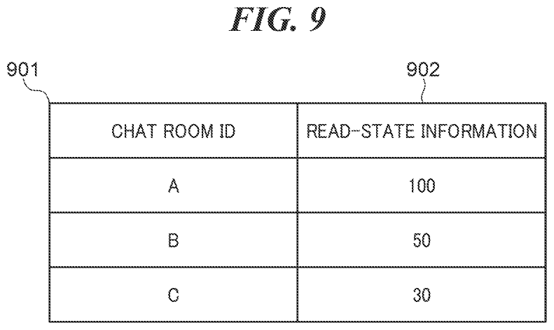

FIG. 9 shows an example of the chat management table 901 which is updated in the step S802. The chat management table 901 is stored in the storage section 302. The chat management table 901 stores chat room IDs (chat room identifiers) and items of read-state information in association with each other.

More specifically, the chat management table 901 manages information on a chat room-by-chat room basis and holds read-state information 902 indicating how many messages have been read by a receiving person in each chat room. The character string (“read”) 403 indicating the read-state information is displayed based on this information when the chat room is displayed. For example, in a chat room A, the read-state information 902 is 100, which indicates that 100 messages are in the read state.

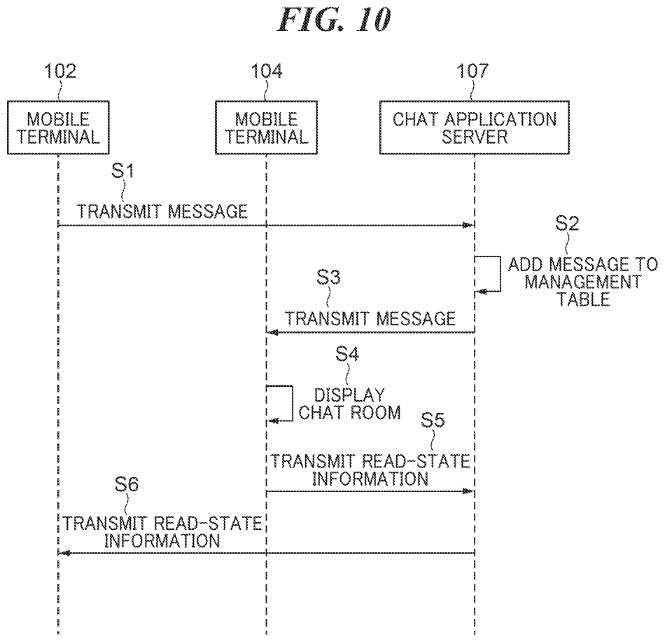

Next, a sequence of operations performed by the whole chat system using the chat application server 107, the mobile terminal 102, and the mobile terminal 104 will be described with reference to FIG. 10. First, the sending person 100 operates the mobile terminal 102 and transmits a message to the chat application server 107 (S1). In response to this, the chat application server 107 adds the message to the chat management table 901 (S2) and transmits the message to the mobile terminal 104 of the receiving person 103 (S3).

Next, the receiving person 103 operates the mobile terminal 104 to display a chat room (S4) and confirms the message. In response to this, the mobile terminal 104 transmits read-state information to the chat application server 107 (S5). Then, the chat application server 107 transmits the read-state information to the mobile terminal 102 (S6). With this, the sending person 100 can recognize that the message has been confirmed. Thus, the sequence of operations is performed by the whole chat system.

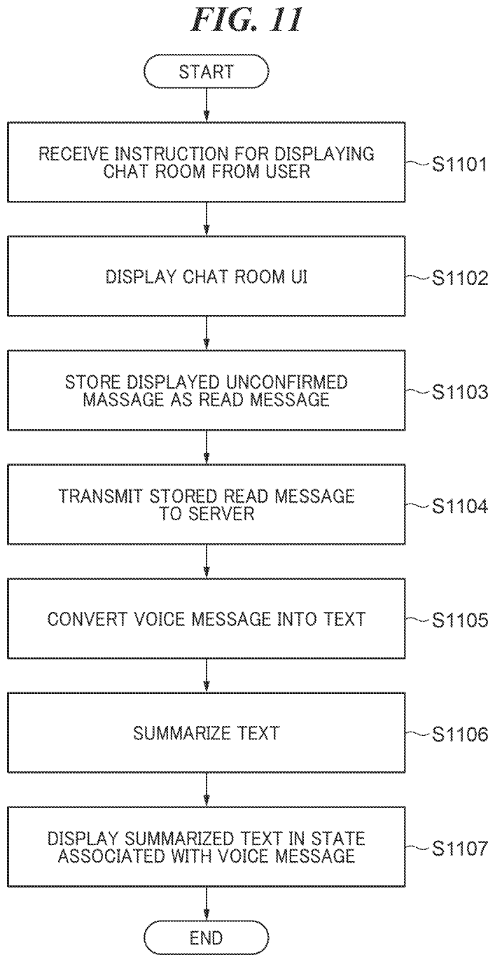

Next, a caption generating-and-displaying process for automatically generating and displaying a caption of a voice message in a chat room of the mobile terminal 104 will be described with reference to FIG. 11. The caption generating-and-displaying process in FIG. 11 can be realized by the controller 301 of the mobile terminal 104 loading an associated control program stored in the storage section 302 into the RAM or the like and executing the loaded control program. First, in a step S1101, the controller 301 receives an instruction for displaying a chat room from the user. Next, in a step S1102, the controller 301 displays the selected chat room on the display section 304.

Next, in a step S1103, the controller 301 stores a latest displayed unconfirmed message in the storage section 302 as the read message. Next, in a step S1104, the controller 301 transmits the read message stored in the storage section 302 to the chat application server 107.

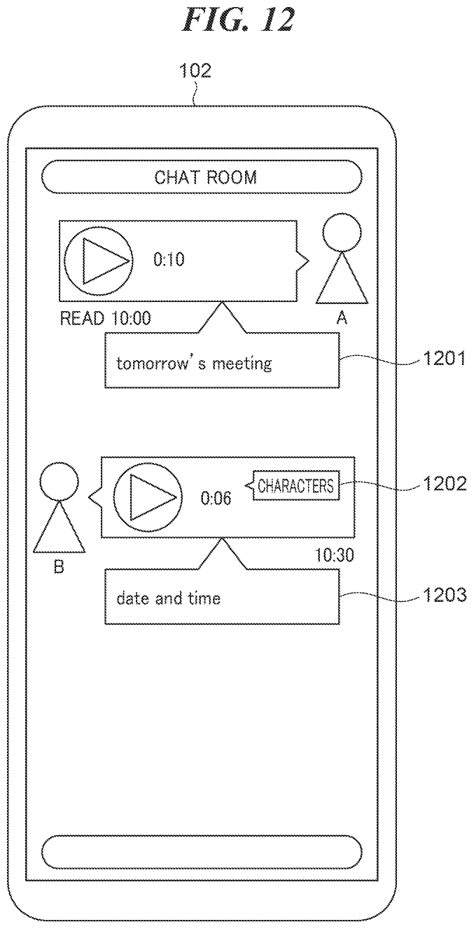

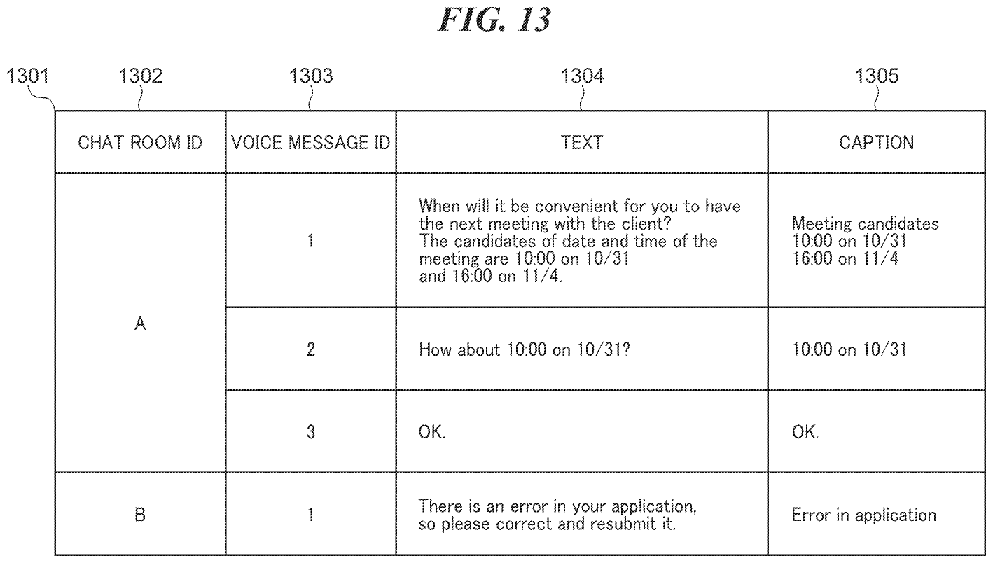

Next, in a step S1105, the controller 301 performs voice analysis on the voice message and converts the voice message into text. Next, in a step S1106, the controller 301 summarizes the text converted from the voice message, to make a caption, in the step S1105. Then, in a step S1107, the controller 301 stores the text generated in the step S1105 and the caption (summarized content) made in the step S1106, in a state associated with the voice message in the chat room, and displays the caption. More specifically, the controller 301 stores, as shown in FIG. 13, the text, denoted by 1304, and the caption, denoted by 1305, in a voice message management table 1301 in association with a chat room ID 1302 and a voice message ID 1303, and displays the caption 1305 on the display section 304 in a state associated with the voice message identified by the voice message ID 1303. Note that even when the voice message is a message transmitted by a user himself/herself or received from a communication partner, the voice message can be displayed in a state associated with the caption (summarized content) (see FIG. 12, described hereinafter) according to the operation described with reference to FIG. 11.

As shown in FIG. 13 by way of example, in the voice message management table 1301, voice message IDs of 1 to 3 are associated with a chat room identified by a chat room ID 1302 of A. Further, the voice message IDs of 1 to 3 are each associated with text 1304 converted from the voice message identified by each voice message ID and the caption 1305 of the text.

For example, the text 1304 and the caption 1305 associated with the chat room ID 1302 of A and the voice message ID 1303 of 3 are “OK” and “OK”, respectively.

FIG. 12 shows an example of the display of the chat room, which is generated by executing the above-described caption generating-and-displaying process. A voice message sent by a user A is displayed in a state associated with a caption 1201. The form of association is display of the associated caption 1201 below the voice message, without any other text message or voice message between the voice message and the caption. The form of association is not limited to this, but can be display of the voice message and its caption in a state connected by a display object, such as a string. Further, a voice message sent by a user B is displayed with a caption 1203 added thereto. Further, the text message sent by the user A and generated by transcription (generated by converting the voice message to text) is displayed in a state in which a display 1202 of “characters” indicating that transcription has been performed is attached to the message so as to enable the text message to be distinguished from other text messages.

Further, by displaying the caption 1201 (summarized content) displayed in a state associated with the voice message in a form different from a normal text message displayed in the chat room, it is possible to distinguish the caption 1201. More specifically, it is possible to use, for example, a form of display in which the caption 1201 (summarized content) associated with the voice message is highlighted by characters and/or a color which are different from those used in normal text messages displayed in the chat room.

Although in the first embodiment, the text displayed in a state associated with the voice message is described as a summary of the message, it can be the first sentence of the message or the like. In the present embodiment, the description has been given of the case where processing after converting a voice message into text is executed on the mobile terminal 104. Note that the content of the summary can be set as a predetermined number of character strings from the start of text into which a voice message is converted, or date and time or a place, described in the character strings.

Further, the text message generated by transcription can be made easy to discriminate by using a method of displaying the display 1202 indicating that transcription has been performed on the message or a method of highlighting the message using characters or a color so as to enable the user to distinguish the message from the other text messages. As described above, by displaying characters as a summary of text converted from the voice message, it is possible to confirm the content of the voice message even in a situation where the voice message cannot be reproduced.

From the above, the following configuration is provided. First, the controller 301 (communication unit) transmits and receives a voice message in a chat room where chatting messages are exchanged between a plurality of users. Next, the controller 301 (text conversion unit, summarization unit) converts the content of the voice message into text and summarizes the text. Then, the controller 301 (display control unit) displays the summarized content in the chat room in a state associated with the voice message.

Note that the configuration can be such that a request for converting the voice message into text and summarizing the text is transmitted to the chat application server 107, and then, in the step S1107, the caption (summarized text) is received from the chat application server 107 and is displayed on the mobile terminal 104. More specifically, to the chat application server 107 (external server) that is capable of converting the voice message to text and summarizing the text into a caption, the controller 301 (request transmission unit) transmits a request for conversion into text and summarization of the text. Further, the controller 301 (reception unit) receives the caption (summarized content) transmitted from the chat application server 107 (external server). Then, the controller 301 displays the received caption (summarized content) in the chat room in a state associated with the voice message. With this, it is possible to generate the summary which is high in accuracy and associate the generated summary with the voice message by using the chat application server 107 having high processing capability.

In the first embodiment, the description has been given of the method of displaying a caption made by summarizing text converted from a voice message. In a second embodiment of the present invention, a description will be given of a form in which whether or not to display a caption on a voice message is switched according to a setting at the time of transmission of the voice message.

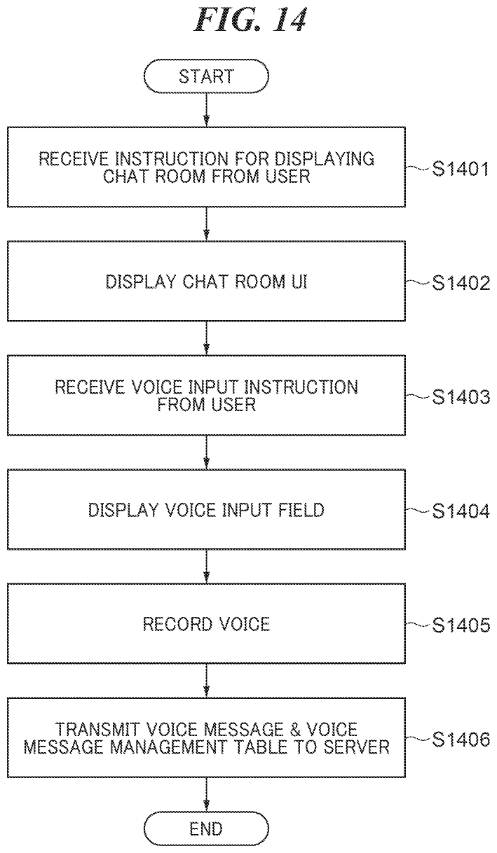

A message transmission process for posting a voice message to which a setting is made as to whether or not to display a caption on the voice message in a chat room of the mobile terminal 102 on the sending person side will be described with reference to FIG. 14. The message transmission process in FIG. 14 is realized by the controller 301 of the mobile terminal 102 loading an associated control program stored in the storage section 302 into the RAM or the like and executing the loaded control program.

First, in a step S1401, the controller 301 receives an instruction for displaying a chat room from a user of the mobile terminal 102. Next, in a step S1402, the controller 301 displays the selected chat room on the display section 304. Next, in a step S1403, the controller 301 receives a voice input instruction from the user.

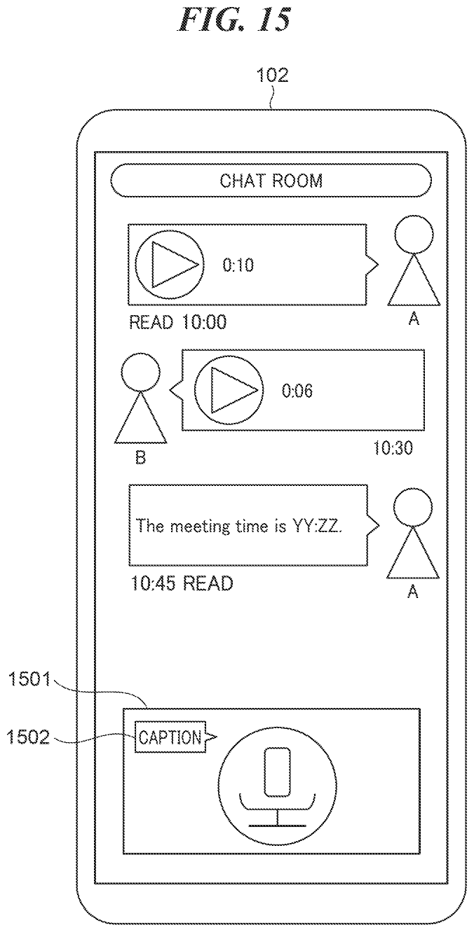

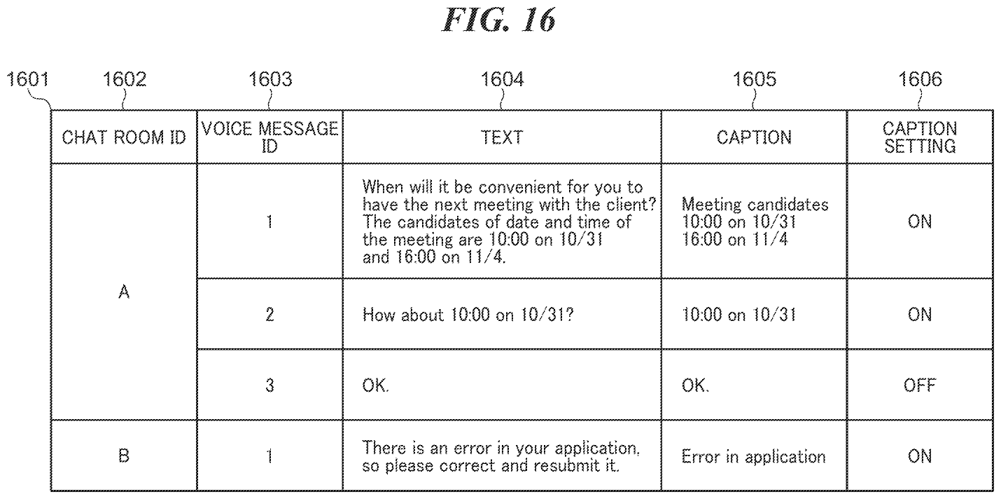

Next, in a step S1404, the controller 301 displays on the display section 304 a voice input field 1501 in which a dedicated button, such as a caption setting button 1502 (see FIG. 15), is displayed. The state of the caption setting set by the caption setting button 1502 is held as indicated by reference numeral 1606 in a voice message management table 1601 shown in FIG. 16 and the voice message management table 1601 is stored in the storage section 302. Next, in a step S1405, the controller 301 starts recording of voice. Then, in a step S1406, the controller 301 transmits the recorded voice message and the voice message management table 1601 to the chat application server 107.

Note that FIG. 16 is an explanatory diagram showing the voice message management table 1601 in the second embodiment. The voice message management table 1601 is configured to store a chat room ID 1602, a voice message 1603, a text 1604, a caption 1605, and the caption setting 1606, in a state associated with each other. As is clear from comparison with the voice message management table 1301 in the first embodiment, shown in FIG. 13, the voice message management table 1601 newly associates the caption setting 1606 with the voice message, compared with the voice message management table 1301. In the caption setting 1606, one of ON and OFF can be set, and ON is a setting for displaying a caption, whereas OFF is a setting for not displaying a caption. For example, for a voice message having a chat room ID 1602 of A and a voice message ID 1603 of 2, the caption setting 1606 is set to ON.

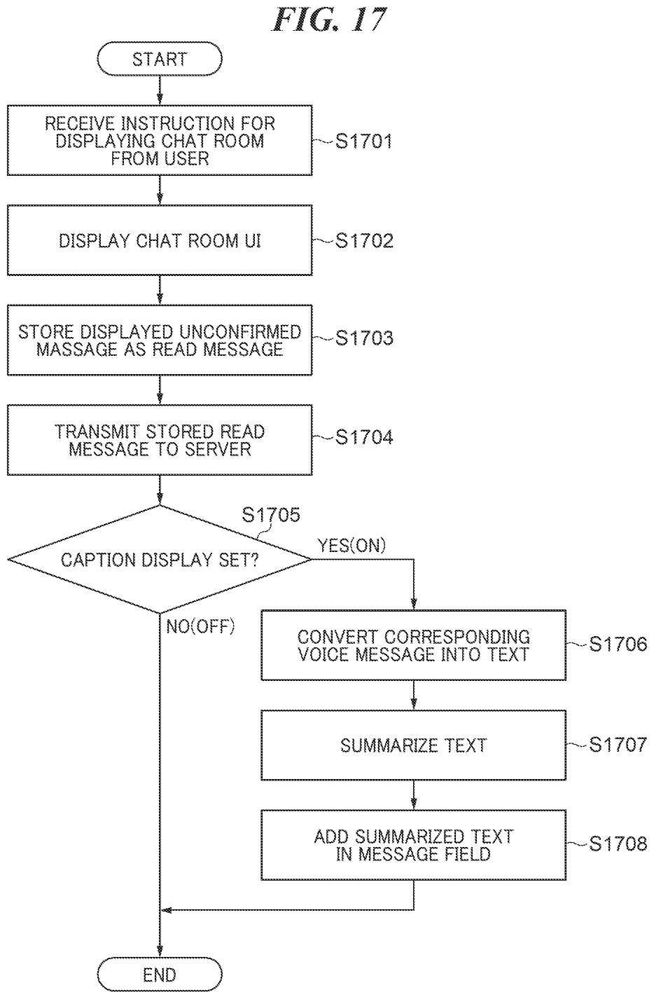

Next, a voice message-displaying process for displaying a caption of a voice message according to a caption setting in a chat room of the mobile terminal 104 on the receiving person side will be described with reference to FIG. 17. The voice message-displaying process in FIG. 17 can be realized by the controller 301 of the mobile terminal 104 loading an associated control program stored in the storage section 302 into the RAM or the like and executing the loaded control program. First, in a step S1701, the controller 301 receives an instruction for displaying a chat room from the user. Next, in a step S1702, the controller 301 displays the selected chat room on the display section 304. Next, in a step S1703, the controller 301 stores a latest displayed unconfirmed message in the storage section 302 as the read message.

Then, in a step S1704, the controller 301 transmits the read message stored in the storage section 302 to the chat application server 107. Next, in a step S1705, the controller 301 determines whether or not the display of the caption has been set, based on the voice message management table 1601 received from the chat application server 107. If it is determined that the caption setting is set to ON (Yes), the controller 301 proceeds to a step S1706. If it is determined that the caption setting is set to OFF (No), the controller 301 terminates the operation.

Next, in the step S1706, the controller 301 analyzes the voice of the voice message and converts the message into text. Next, in a step S1707, the controller 301 summarizes the text. Then, in a step S1708, the controller 301 displays the summarized text on the display section 304 as the text message 1201 as in the case of the normal message.

A summary of the second embodiment is as follows: First, the chat room displayed on the mobile terminal 102 on the sending person side is further provided with the caption setting button 1502 (caption presence/absence-setting unit) for setting whether or not to attach a caption (summarized content) to a voice message when the voice message is transmitted. Then, the controller 301 controls the display of the caption (summarized content) associated with the voice message in the chat room, based on the setting made by the caption setting button 1502 (caption presence/absence-setting unit).

As described above, it is possible to switch whether or not to display the caption (summarized content) of the voice message, based on the caption setting which is information indicating a setting of display of the caption to be attached when the voice message is transmitted.

Next, a third embodiment of the present invention will be described. A user sometimes desires to search for a voice message afterwards, and hence, in the third embodiment, a description will be given of an example of operation performed for searching for a voice message by searching text using an character string input by the user.

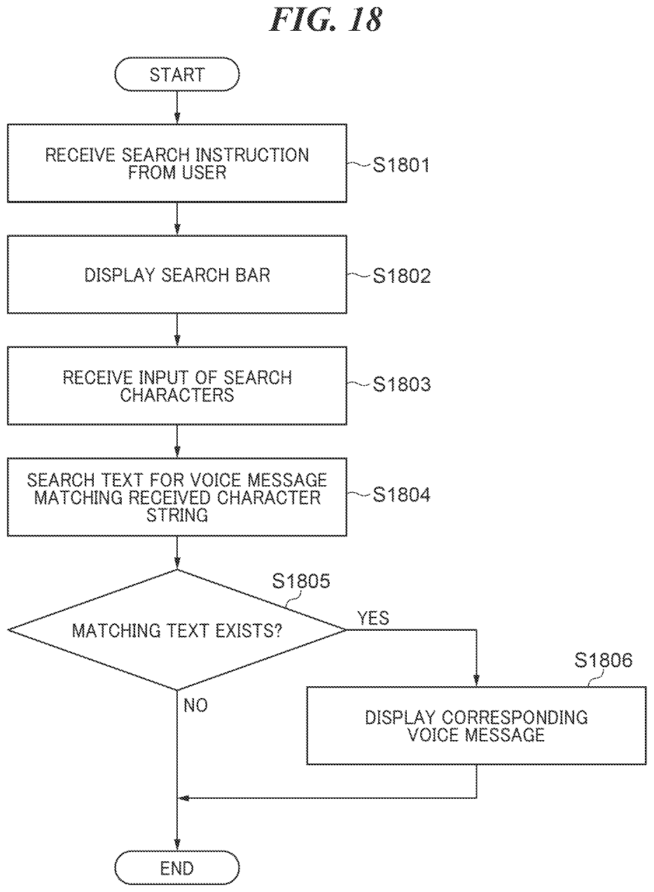

A voice message-searching process performed by the mobile terminal 102 will be described with reference to FIG. 18. The voice message-searching process in FIG. 18 can be realized by the controller 301 of the mobile terminal 102 loading an associated control program stored in the storage section 302 into the RAM or the like and executing the loaded control program.

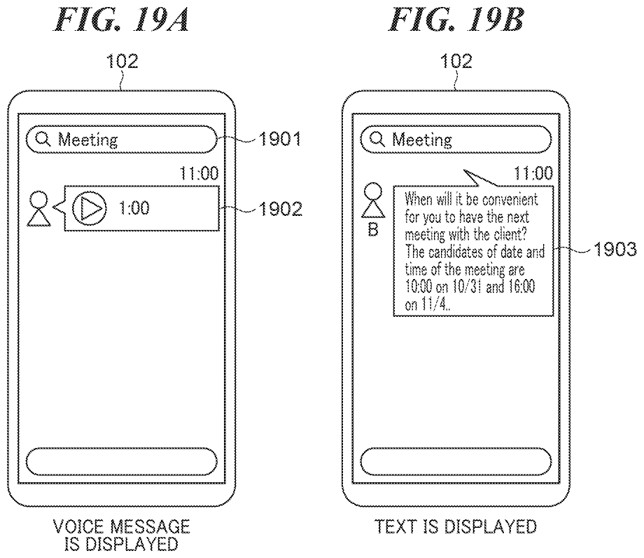

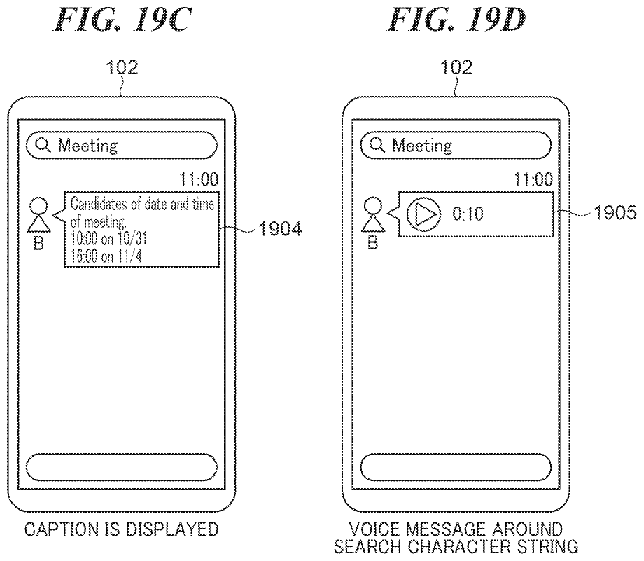

First, in a step S1801, the controller 301 receives a search instruction from the user. Next, in a step S1802, the controller 301 displays a search bar 1901 appearing in FIG. 19A on the display section 304. As shown in FIG. 19A, the search bar 1901 is disposed as a laterally long area on an upper portion of the display screen, but the location where the search bar 1901 is disposed is not limited to this location.

Next, in a step S1803, the controller 301 receives an input of a search character string from the user. Next, in a step S1804, the controller 301 searches the voice message management table 1301 for the text 1304 which includes a character string matching the character string received in the step S1803.

Next, in a step S1805, the controller 301 determines whether or not a character string matching the character string searched for in the step S1804 exists. If it is determined that the matched character string exists (Yes), the controller 301 proceeds to a step S1806. On the other hand, if it is determined that the matched character string does not exist (No), the controller 301 terminates the operation. Then, in the step S1806, the controller 301 displays a corresponding voice message 1902 on the display section 304.

The search result displayed on the display section 304 is not limited to the voice message 1902, but the configuration can be such that text 1903, a caption 1904, or a voice message 1905 extracted from voice around the search character string is displayed. FIG. 19A shows an example of the display in which the voice message 1902 is displayed as the search result, and FIG. 19B shows an example of the display in which the text 1903 is displayed as the search result. Further, FIG. 19C shows an example of the display in which the caption 1904 is displayed as the search result, and FIG. 19D shows an example of the display in which the voice message 1905 extracted from the voice around the search character string is displayed as the search result. Note that the search target is not limited to text, but can be text and captions (summarized contents), or text or captions (summarized contents).

A summary of the third embodiment is as follows: First, the controller 301 (reception unit) of the mobile terminal 102 receives an input of a search character string in the search bar 1901 displayed in the chat room. Then, the controller 301 (search unit) searches for text converted from a voice message and/or a caption (summarized content) using the received character string as a search key. As described above, in a case where a user desires to search for a voice message, it is possible to retrieve the voice message by converting the voice message into text (characters).

Although the above description has been given of the example in which a chat is performed between mobile terminals, the above-described operation can be also realized, for example, between PCs, such as a desktop-type PC and a laptop-type PC, or between a PC and a mobile terminal. In this case, the PC can be connected to a router by wired connection via a LAN cable or can be connected to a wireless router. Further, the laptop-type PC can be a portable type. However, it is necessary to install the application program (AP) according to the present invention and incorporate or externally mount a microphone for inputting voice and a speaker for outputting voice, in/on the PC.

By displaying a chat room itself as a three-dimensional image and also displaying text as a three-dimensional image, the user can three-dimensionally recognize the chat room and the character string generated by converting a voice message to text, by wearing dedicated glasses, dedicated goggles, or the like. At this time, if an avatar of the user himself/herself and an avatar of a partner are set in advance and displayed in appropriate positions, the user can enjoy the chat more.

The user determines colors for chat types (a chat for friends, a chat for business, and a chat for a certain meeting), respectively, in advance. Then, a key word (such as date and time or a place) is extracted from text converted from the voice message, and the controller 301 determines, based on the extracted key word, a type of the chat and displays character strings of the text to which the associated color is applied. This enables the user to roughly grasp the content of the chat.

By performing a specific operation, such as a long-pressing operation, with respect to a reproduction icon, which has a triangular shape, of a voice message, it is possible to display text converted from the voice message in the display area of the voice message without outputting voice. At this time, in a case where the text is not short enough to be displayed within the display area, it is also possible, by performing an operation of sliding the text, to sequentially slide and display the text to make the same visible.

By concluding an agreement that the voice message is necessarily converted to text with a management entity of the chat application server 107, it is possible to realize the variety of above-described processes by the mobile terminal with high accuracy without sending a request to the chat application server 107 each time.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-025294 filed Feb. 21, 2023, which is hereby incorporated by reference herein in its entirety.

What is claimed is:

1. A non-transitory computer-readable storage medium storing a program for causing a computer to execute a control method of controlling an information processing apparatus, the control method comprising:
causing the information processing apparatus to execute processing for summarizing content of a voice message in a chat room where chats are posted by a plurality of users; and
causing the information processing apparatus to display summarized content in a state associated with the voice message.

2. The storage medium according to claim 1, wherein the content summarized by the processing is displayed in a form different from normal text messages displayed in the chat room.

3. The storage medium according to claim 2, wherein the content summarized by the processing is displayed in a display form including a character and a color which are different from the normal text messages displayed in the chat room.

4. The storage medium according to claim 1, wherein the control method further comprises receiving a setting for setting whether or not to attach the content summarized by the processing to the voice message when the voice message is transmitted,
wherein the summarized content is displayed based on the setting.

5. The storage medium according to claim 1, wherein the processing converts the content of the voice message to text, and summarizes the text.

6. The storage medium according to claim 5, wherein the processing summarizes the content of the voice message based on a predetermined number of character strings from a start of the text, or date and time and a place which are described in the text.

7. The storage medium according to claim 4, wherein the control method further comprises causing the information processing apparatus to display an object for receiving a setting for setting whether or not to attach the content summarized by the processing to the voice message when the voice message is transmitted.

8. The storage medium according to claim 1, wherein the control method further comprises:
receiving an input of a character string, and
causing the information processing apparatus to search for the summarized content using the received character string.

9. The storage medium according to claim 1, wherein the processing for summarizing the content of the voice message is processing for causing an external server to summarize the content of the voice message and receiving the summarized content.

10. The storage medium according to claim 1, wherein the information processing apparatus is a mobile terminal.

11. A method of controlling an information processing apparatus, comprising:
causing the information processing apparatus to execute processing for summarizing content of a voice message in a chat room where chats are posted by a plurality of users; and
causing the information processing apparatus to display summarized content in a state associated with the voice message.

12. An information processing apparatus, comprising:
an execution unit configured to execute processing for summarizing content of a voice message in a chat room where chats are posted by a plurality of users; and
a display unit configured to display summarized content in a state associated with the voice message.
